(19) United States
(12) Patent Application Publication
(10) Pub. No.: US 2007/0234973 A1
(43) Pub. Date: Oct. 11, 2007

(54) Securing device for animal hygiene

(76) Inventor: Keith Derrick Thames Sunderland, London (GB)

Correspondence Address: MR. KEITH SUNDERLAND;FLAT 17, 87 RONALDS ROAD, HIGHBURY, LONDON, N5 1XQ, omitted

(21) Appl. No.: 11/724,666

(22) Filed: Mar. 16, 2007

(30) Foreign Application Priority Data
Apr. 6, 2006 (GB) 0606937.1
Feb. 5, 2007 (GB) 0702149.6

(51) Int. Cl. A01K 23/00

(52) U.S. Cl. 119/868

(57) ABSTRACT

A retractable harness device for use as part of an animal hygiene system particularly for dogs. Comprising a housing attaching at its forward facing edges to an animal's harness by means of straps. From apertures in the housing extend two cords which are payed out along a dogs back under tension from retractable mechanisms within the housing. Releaseable bag-attaching members with stop guards are permanently joined to the ends of the cords. The attaching members attach to corresponding points on a suitable waste collection bag securing the bag beneath the the animal's tail in order to collect solid waste. The device may incorporate a tensioning mechanism to increase tension on the extended cords to allow for the body movements and additional weight of deposits of larger animals.

### CROSS-REFERENCE TO RELATE APPLICATIONS

This non-provisional utility patent application claims priority from earlier filed UK Patent Applications: GB 0606937.1 and 0702149.6
Title: Securing Device For Animal Hygiene
Filing Date: 6 Apr. 2006 and 5 Feb. 2007
These applications apply to the same invention.

### STATEMENT REGARDING FEDERALLY SPONSORED RESEARCH OR DEVELOPMENT

‘Not Applicable’

### REFERENCE TO SEQUENCE LISTING, A TABLE OR A COMPUTER PROGRAM LISTING COMPACT DISC APPENDIX

‘Not Applicable’

### BACKGROUND TO THE INVENTION

A study of prior art discloses that in attempting to secure an animal waste receptacle to the rear of a live quadruped, numerous innovators have designed cont. various forms of ‘static’ harness arrangements. These may or may not be adjustable but all remain in a fixed position on the animal.

Examples of static harnesses described in published US patents are:
Fujinara U.S. Pat. No. 5,813,369 A fixed harness extending from the dog's collar and straddling the dorsal region.
Hang-Fu U.S. Pat. No. 5,386,802 A fixed strap harness structure originating from the animal's own harness.
Raphael U.S. Pat. No. 5,937,795 A fixed harness arrangement attaching to a dog's own collar which extends above and beneath the animal.
Berardo U.S. Pat. No. 4,444,152 A strapped harness structure which encircles the hind-quarters and legs of a dog.

The present invention seeks to overcome problems associated with the habitual attachment and detachment of a static harness structure to a domestic quadruped prior to daily walking.

A static harness may be inefficient in retaining an appropriate collection bag in the correct position prior to and after defaecation.

Fixed strap harnesses may become soiled and weather worn after prolonged use.

Some dog owners may experience frustration with the chore of attaching and cont. detaching a harness to their pet on a daily basis.

### BRIEF SUMMARY OF THE INVENTION

The present invention seeks to provide a retractable harness device, as part of an animal waste collection system, in which a housing is releaseable attached to an animal's own harness or collar and contains at least one retractable mechanism operating to store, extend and retract cords through apertures, the cords serving to secure via fixing members an animal waste collection bag to the rear of an animal inorder to collect solid waste voided by the animal.

A first aspect of the inventions provides a convenient and discreet means of attaching a waste collection container to an animal via a device which does not necessitate the use or appearance of a cumbersome and complicated harness system which may extend along and around the body of an animal or between its legs thereby impeding it's movement.

In use, retractable or cords can be payed out from a discreet and light-weight housing which has attachment portions which connect to an animal's own collar or harness, A suitable waste collection bag (not part of the present invention) with co-operable attachment points may then be attached to releaseable attachment connectors joined to the payed-out ends of the cords after being correctly positioned at the rear of a dog.

In operation, retractable mechanisms accommodated in the light-weight cont. housing maintain a flexible tension on the cords which keeps the opening of the bag in position with the cloacal orifice of the animal and allows for the animal's body movements. After the bag is detached for hygienic disposal the cords are automatically retracted into the housing. The device may then remain attached to an animal's collar or conventional harness ready for use.

### BRIEF DESCRIPTION OF THE SEVERAL VIEWS OF THE DRAWINGS

Embodiments of the invention will now be described in detail with reference to the accompanying drawings in which:

FIG. 1 is a perspective rear view of a dog showing the device attached to the animal's own conventional harness and attaching to a collection bag.

FIG. 1A is a partial view of a pair of retractable cords with shield stops and bag-attaching loops or studs mounted at the extreme ends of said cords.

FIG. 2 is a perspective view of a retractable harness device with an exploded view of one of two operable spring-powered reels. Payed-out cords terminate in snap-fasteners and are linked by a slideable transverse strap.

FIG. 3 is a cross-sectional view of the device incorporating an adjustable tensioning mechanism vertically mounted, top-most the housing.

FIG. 4 is a perspective view of the underside of a retractable harness device which incorporates a single attaching clip.

FIG. 5 is a perspective view of the underside of a retractable harness device with two aligned projecting slots integral the housing.

FIG. 6 is a perspective view of a dog from the rear showing the device with a single retractable mechanism integral to a purpose made harness structure and attaching to a collection bag via shield-mounted hooks.

FIG. 6A is a partial view of a single retractable cord having at its extreme payed-out end a triangular piece of fabric attached to a branching pair or cords which terminate in bag-attaching hooks.

### DETAILED DESCRIPTION OF THE INVENTION.

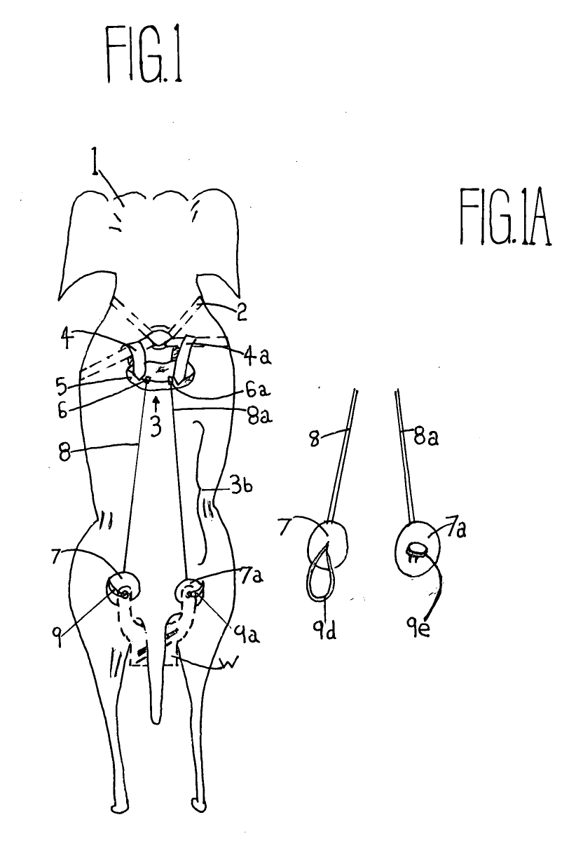

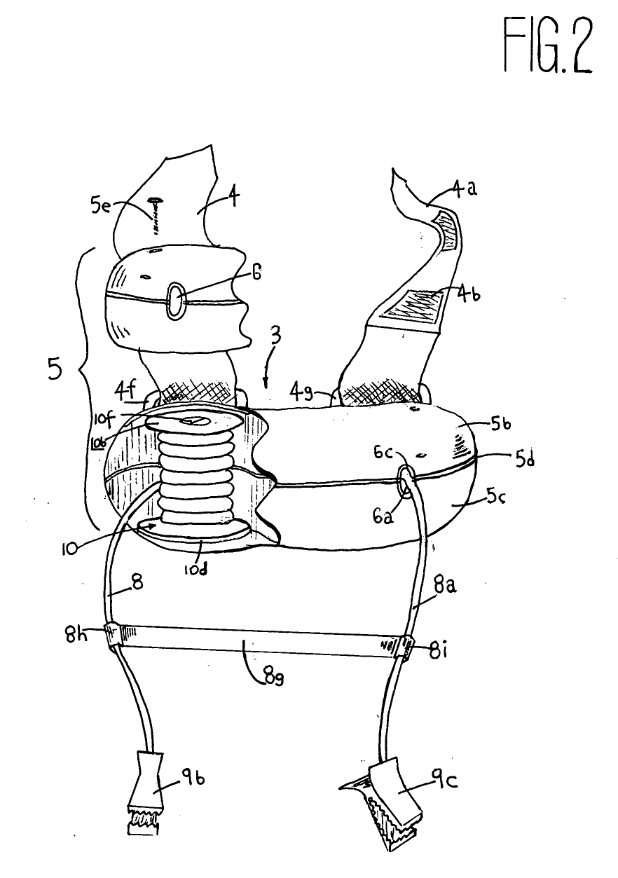

Referring now to the drawings: FIG. 1. shows a dog 1 in rear view wearing a conventional harness 2. The retractable harness device 3 is attached to the girth component of the conventional harness by means of attachable straps 4 and 4a waste collection bag W (not part of the present invention) is secured to the rear of the dog via attachable and detachable hooks 9 and 9a situated at the extremeties of cords 8 and 8a which emerge from apertures 6 and 6a. Apertures 6 and 6a may be suitably coated, padded or reinforced (FIG. 2) to prevent damage to through passing cords. In a further embodiment, FIG. 1A shows said emerging cords 8 and 8a which have mounted at their extreme payed-out ends, shield shaped stops incorporating co-operating loop or stud members as an alternative securing means.

FIG. 2 shows a housing 5 of moulded hardened plastic, metal or rubber material substantially containing two operable retractable mechanisms 10 and 10a. The term ‘retractable mechanism’ includes any mechanism for storing, permitting cont. extension of at least part of said cord and re-storing of said cord or known to those skilled in the art.

In the embodiments shown in FIGS. 1, 2, 3, 4 and 5 the retractable devices are two spring-loaded reels 10 an 10a mounted on central pins or columns 10f and 10g. A coiled spring 10i and 10j applies to spool 10 and 10a for retracting and winding cords 8 and 8a on to their respective spools. In the Figures the sprung reels 10 and 10a are mounted in a lateral plane, side by side with sufficient clearance between the reels and the housing 5 to permit free rotation or operation of any other retractable device.

It is envisaged that the interior and exterior of the housing 5 may be shaped and embody structures such as recesses, ribs, hollows, separating cavities or walls that facilitate the operation of spring-loaded reels or any other retractable device. Further that the housing 5 may be shaped or constructed to hold retractable devices such as spring-powered reels or spools in the positions shown in the Figures or in any other workable configuration such as side by side in a vertical or lateral plane, substantially overlapping, placed one on top of the other or in an irregular plane operating independently of each other.

In FIGS. 1, 2, 4 and 5 the housing 5 has a curved ‘figure of eight’ shape. It is further envisaged that the housing 5 may be substantially rectangular, triangular, circular, hexagonal or of any other regular or irregular shape. Said housing may have concave or convex surfaces or a combination of both, and may feature protruding or recessed features so as to accommodate cont. at least one retractable mechanism and all related features. It is understood that the exterior surfaces of the housing 5 may curved or planular surfaces or a combination of both which may be tooled with a pattern or smooth. The housing may have apertures and structures integral and/or auxiliary to the main housing, interior or exterior the container to allow for the operation of retractable mechanisms in any operable configuration.

Further, said housing may accommodate fluorescent reflecting material in addition the housing 5 may be personalised with identity details.

In FIGS. 1, 2, 3, 4, 5 and 6 the housing 5 is formed from at least two moulded compatible sections 5b and 5c which fit together to form a box or closed container with apertures. In the embodiments shown it is understood that the housing 5 has internal arrangements on which the reels 10 are mounted and which serve as an additional link between sections of the housing 5b and 5c.

The housing 5 may be formed from two or more sections that secure together by means of conventional joints or fixings such as screws 5e, bolts or rivets, co-operating male and female connections, operating plastic joints or hinges (Not Shown). These fixings may be situated around the corresponding peripheries 5d, interior or exterior the perimeters of the housing edges and surfaces that join together.

It is further envisaged that interior or exterior areas of the housing 5 or its corresponding peripheries may have releaseable fixings such as clips, studs, abutments, latches or lever and claw clasps. Further, that sections of the housing may pivot or slide open and closed to allow part of the casing to be temporarily opened for the purpose of the replacement of worn components.

It is understood that the connecting or releaseable edges of any suitably shaped housing shall be formed to secure together by any conventional joint or any suitable operable joint known in the art.

In FIGS. 1, 2, 3, 4 and 5 two spring-loaded reels 10 and 10a function to store, pay out and re-store cords 8 and 8a. These cords see FIGS. 1 to 6 emerge through spaced apertures 6 and 6a in the housing 5. These apertures 6 and 6a are situated so as to facilitate the efficient paying-out and retrieval of the cords 8 and 8a . Said cords may be linked laterally across their payed-out lengths by at least one transverse strap part 8g. Said transverse strap part 8g having looped or attachable features 8h and 8i at the extreme adjacent ends conjoining with cords 8 and 8a enabling the transverse strap part(s) to slide along the extended cords in the region of 3b shown in FIG. 1. Alternatively, the adjacent connections 8h and 8i at either of the extreme ends of said transverse strap part(s) 8g envisaged, may be permanently joined to the extreme ends of the cords 8 and 8a that are not cont. permanently joined to a retractable device. Said transverse strap parts 8g may be gripped, in use, when extension of the cords occurs and may be used as an anchoring device for variously-shaped dogs. It is yet further envisaged that said transverse strap part 8g may be of reinforced material.

Further, it is foreseen that said cords 8 and 8a may be coated or formed from anti-kink material, plasticised or fashioned in such a way as to prevent tangles in animal fur or within the housing 5.

The extreme ends of said cords 8 and 8a which are not attached attached to a retractable mechanism are permanently connected to bag-attachment hook-members 9 and 9a or other suitable attachable devices which may be snap fasteners 9b and 9c FIG. 2 or loops or studs 9d and 9e FIG. 1A. Said bag attaching members co-operate with fixing points on a purpose-made waste collection bag or to any suitably shaped waste collection container, thus securing the opening of the container in alignment with the anus of the animal at required times. Said bag fixing members are sufficiently large enough to act as stops to prevent the retracted cord(s) from being entirely drawn back into the housing after being disengaged from attaching points on the collection receptacle after defaecation has occurred.

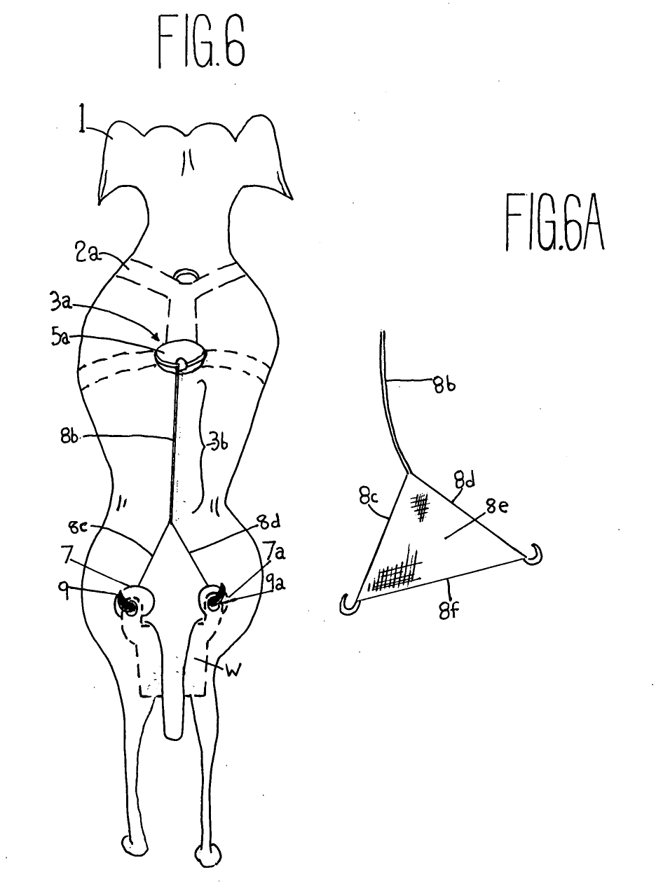

In FIGS. 1 and 6 the hooked shaped bag-attaching members 9 and 9a incorporate plastic or rubberised washers or shields 7 and 7a to more effectively prevent this and for easier handling purposes.

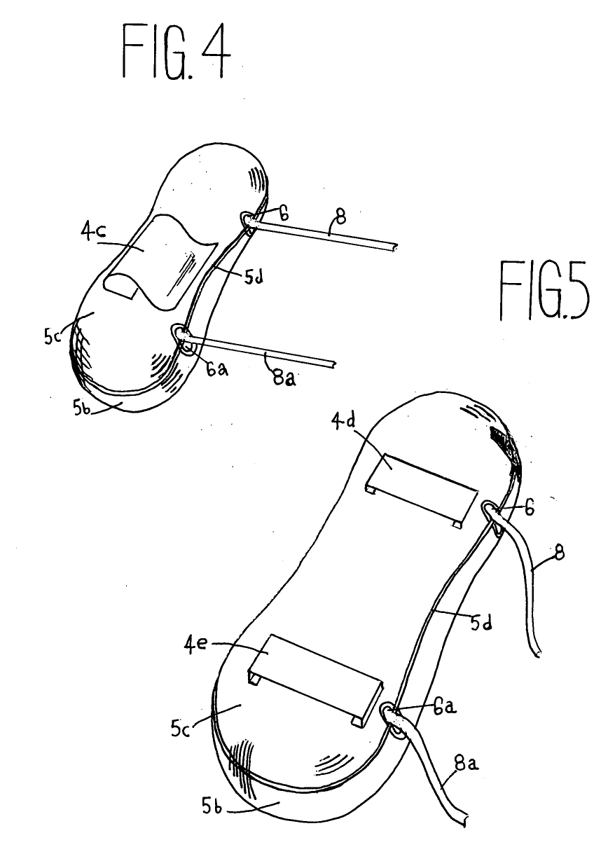

In FIG. 2 the front facing edge of the housing 5 shows a pair of attachable clip structures 4f and 4g to enable the device to be attached and detached via attaching straps 4 and 4a to an animal's own collar or harness. FIG. 4 shows the underside of the lower section 5c of a substantially oval-shaped housing incorporating a single attaching clip 4c and in FIG. 5 the underside of a ‘figure or eight’ shaped housing has a pair of integral attaching slots or brackets 4d and 4e to enable a strap of flexible material to be passed through for attaching purposes.

Said device 3 may have straps of flexible material such as leather, nylon webbing or plastic permanently secured via integral slots, clips or any suitable means known in the art. These flexible strap parts 4 and 4a act as releaseable fixings on to an animal's own collar or harness to allow cords 8 and 8a to be payed out along the animal's dorsal region 3b towards the tail. It is further envisaged that these attachable and releaseable straps may be permanently attached to the housing 5 by any suitable means.

At spaced intervals along releaseable straps 4 and 4a are provided pads or co-operating material of hook and loop fastening 4b which enable straps 4 and 4a to form attachment loops with an animal's harness or collar prior to the use of the device 3. In other embodiments FIG. 4 the invention may be secured to an animal's own collar or harness by means of a single releaseable fixing member 4c.

In yet further embodiments of the present invention the device may be attached to an animal collar or walking harness via at least one slot 4e FIG. 5 or attachable and detachable clip 4c FIG. 4 or a combination of both structures. Said attachable and detachable structures may feature at least one attaching strap 4 and said structures may be variously aligned, projecting or non-projecting from the exterior surface of the housing 5, integral or detachable from said housing.

It is understood that in other embodiments of the device 3 said attachable straps 4 and 4a may incorporate other conventional fastenings such as slideable-buckles, hooks or snap-fastenings.

It is yet further envisaged that the present invention may be permanently or temporarily incorporated into the structure of an animal's collar or harness by means known to those skilled in the art.

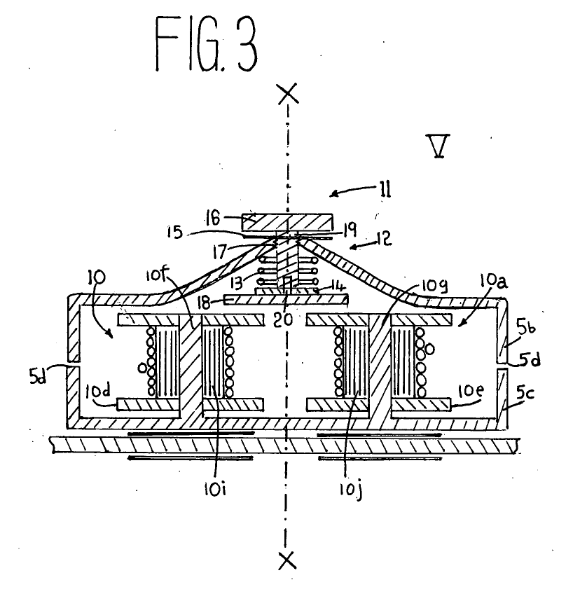

In an alternative embodiment shown in FIG. 3 the housing 5 incorporates a tensioning or braking device 11. In FIG. 3 said tensioning device 11 is situated centrally and topmost the upper section 5b of housing 5. In the drawing in FIG. 3 said housing embodies a raised area 12 which may be reinforced so as to accommodate said tensioning device. Alternatively in other embodiments there may be no obvious increase in thickness or reinforcement in the housing.

Central the area in said housing 12 FIG. 3 a hole with a screw thread 17 is channelled vertically downwards through the upper surface of the housing section 5. A purpose-made screw 19 engages with co-operating thread 17 and passes down through the top section of housing 5b. The turning head 16 of cont. said screw 19 may be of any shape and may feature callibrations on its upper surface in order to indicate varying tensions. Further, said turning head 16 may have tooled patterning about its vertical edges.

A suitable washer 15 FIG. 3 which may be of the sprung type may be employed to separate the gripped head 16 of screw 19 from the housing 5.

At the base of said screw a substantially circular holding plate 14 is attached through its centre by means of a connecting screw or rivet 20 or other means into the shank of the operating screw 19.

To the underside of said holding plate 14 is attached a disc of padded or flexible material 18 such as felt, rubberised foam, soft plastic or cloth. Said pad 18 may be formed of brushes.

In the embodiment shown in FIG. 3 said pad of flexible material 18 has sufficient depth and flexibility to provide variable and gradual pressure when engaged. Said pad 18 may be circular or have regular dimensions and completely cover the underside of holding plate 14 or exceed its diameter. Said pad 18 may be glued onto the engaging surface of the holding plate 14 or may be screwed into position by means of a counter-sunk screw penetrating both pad 18 and plate 14 into the shank of the screw 15.

Further, in the embodiment shown in FIG. 3 a helical spring 13 which may be accompanied by at least one washer surrounds the shank of the screw 15 between the upper-surface of the casing 5b and the padded holding plate 14.

In use, said cords or tapes, already under a measure of tension determined by the sprung-reels 10 and 10a may be further tensioned, to suit the body movements and the additional weight of waste deposits within a collection bag for larger animals.

In use, a slight turning of the screw's turning head 16 which may show graduated figures or numerals, engages the soft pad 18 at gradually increasing pressures in a vertical plane against the perimeters of the upper surface of the reels at points 10h.

It is yet further envisaged that said tensioning device 11 as described in FIG. 3. may be positioned in a lateral plane through either the backward facing edge or the forward facing edge of housing 5. In this configuration the soft pad 18 engages with the rims 10d and 10e of the two reels 10.

In an alternative embodiment shown in FIG. 6 a dog 1 is shown in perspective rear view wearing a harness structure 2a. A retractable harness device 3a with housing 5a contains a single functioning spring-powered reel or other retractable mechanism. Said device 3a is integrally attached to said collar structure 2a similarly said device 3 or 3a may be integrally a part of a walking harness structure or both said devices may attach to a conventional collar or walking harness by means already described.

A payed-out cord 8b emerges from aperture 6 in housing 5a. Said payed-out cord 8b has branching cord members 8c and 8d which terminate in shield stops 7 and 7a and bag attaching hooks 9 and 9a to which suitable waste collection bag W (Not part of the present embodiment) is secured to the anal region of the animal.

FIG. 6A of the drawings further envisages that said branching cord-members 8c and 8d may have permanently or temporarily attached along their entire lengths a piece of substantially triangular shaped, weather-proof fabric 8e.

In use, backward-facing leading edge of said attached fabric 8f may be gripped to more easily facilitate the extension of a single retractable cord 8b from the device. When cord 8b is fully retracted, said fabric 8e may be folded back over said device 3a and branching hooks 9 and 9a secured to the transverse element of an animal harness or collar.

The device as described shall be substantially robust and weather-proof in construction and the essential forms and details of the device thus described may be varied but such variations are not to be regarded as a departure from the spirit and scope of the invention.

All such modifications as would be obvious to those skilled in the art are intended to be included within the scope of the following claims:

I claim:

1. A retractable harness device to be used as part of an animal waste collection system for securing a faeces collection bag to a domstic quadruped comprising:
a weather-proof housing, having external attachment means to attach said housing to a domestic quadruped substantially about the region of the neck and shoulders; at least one spring-powered retractable mechanism accommodated operably by structured elements within the housing; said spring-powered retractable mechanism(s) operating to permit the storage, extension and retraction of corresponding cords through corresponding reinforced apertures, entire retraction of said cords back into the housing being being prevented by attachable and releaseable bag-attaching members permanently joined to the extreme payed-out ends of the cords, said cords with bag-attaching members extend in use under tension, along an animal's back directionally towards the anal region of the animal so as to secure to corresponding attachment points on any co-operable purpose-made animal waste collection bag, thus securing such a bag to the rear of an animal for the purpose of collecting solid waste material voided by the animal.

2. A device according to claim 1 wherein said housing is formed of at least two corresponding structures.

3. A device according to claim 1 wherein said housing incorporates at least one slot structure capable of having a strap of flexible material passed through for the purpose of attaching said device to an animal.

4. A device according to claim 1 wherein said housing further incorporates at least one detachable clip structure for the purpose of attaching the device to an animal collar or walking harness.

5. A device according to claim 1 wherein said housing further incorporates a manually-operated screw-adjustable tensioning mechanism compatibly and co-operably mounted to operate, frictionally with graduated pressure via at least one pad of soft material or brushes on the rims or surfaces of spring-powered reels or spools operably contained within said housing.

6. A device according to claim 1 wherein said external attachment means is at least one flexible strap with a buckle and slideable adjuster or spaced pads of co-operating hook and loop material, co-operably attached to the housing, said strap capable of forming an attaching loop to an animal's conventional walking harness or collar.

7. A device according to claim 6 wherein said flexible strap is capable of forming an animal collar or shoulder harness.

8. A device according to claim 1 wherein the retractable mechanism is two spring-powered reels, independently operating, side by side, in a lateral plane.

9. A device according to claim 1 wherein said payed-out cords are conjoined by and maintained in parallel by at least one slideable transverse strap part of reinforced flexible material.

10. A device according to claim 1 wherein said attachable and releaseable bag-attaching members are hooks or co-operating male or female loop or stud connections or snap-fasteners.

11. A device according to claim 1 wherein shield structures are mounted between said bag-attaching members and payed-out cord ends.

12. A retractable harness device to be used as part of an animal waste collection system for securing a faeces collection bag to a domestic quadruped comprising:
a weather-proof housing; external attachment means to attach said housing to a domestic quadruped substantially about the neck and shoulder region; a spring-powered retractable mechanism accommodated operably within said housing by structured co-operable elements;
said retractable mechanism operating to permit the storage, extension and retraction of one cord through a corresponding reinforced aperture in said housing; said cord being permanently attached to said

12. cont. retractable mechanism at one end, the other end of said cord terminating and diverging into a pair of cords in a V-shaped configuration; entire retraction of said cord and V-shaped cords back into the housing being prevented by attachable and releaseable bag-attaching members permanently joined to the extreme payed-out ends of said V-shaped cords; said cords with said releaseable bag-attaching members extend, in use, under tension when drawn out from said housing, along an animal's back, directionally towards the anal region of said animal so as to attach via said releaseable and attachable bag-attaching members to corresponding attachment points on any co-operable purpose made animal waste collection bag, thus securing such a bag to the rear of an animal for the purpose of collecting solid waste material voided by the animal.

13. A device according to claim 12 wherein said housing is formed of at least two corresponding structures.

14. A device according to claim 12 wherein said housing incorporates at least one aligned slot structure capable of having a strap of flexible material passed through for the purpose of attaching said housing to an animal.

15. A device according to claim 12 wherein said housing incorporates at least one detachable clip structure for the purpose of attaching and detaching said device to an animal's collar or conventional walking harness.

16. A device according to claim 12 wherein said housing further incorporates a manually-adjustable, screw-operated tensioning mechanism, frictionally acting with graduated pressure, via a pad or brush on a rotatable spring-loaded reel operably contained within said housing.

17. A device according to claim 12 wherein said external attaching means is at least one flexible strap of nylon webbing or other suitable material with a buckle and slideable adjuster or spaced pads of co-operating hook and loop material co-operably attached to said housing, said flexible strap capable of forming an attaching loop to an animal's collar or conventional shoulder harness.

18. A device according to claim 17 wherein said flexible strap is adaptable to forming an animal collar structure or a walking harness structure.

19. A device according to claim 12 wherein said retractable mechanism is one spring-loaded reel.

20. A device according to claim 12 wherein said V-shaped configured cords further incorporate a substantially triangular shaped piece of fabric.

21. A device according to claim 12 wherein said bag-attaching members are hooks or co-operating male or female loop or stud connectors or snap fasteners.

22. A device according to claim 21 wherein shield structures are mounted between said bag-attaching members and said cord payed out ends.
